(19) United States
(12) Patent Application Publication
(10) Pub. No.: US 2005/0219434 A1
(43) Pub. Date: Oct. 6, 2005

(54) Liquid crystal display panel and manufacturing method thereof

(75) Inventor: Hiroshi Sakurai, Kanagawa (JP)

Correspondence Address: MCGINN & GIBB, PLLC, 8321 OLD COURTHOUSE ROAD, SUITE 200, VIENNA, VA, 22182-3817, US

(73) Assignee: NEC LCD Technologies, Ltd., Kawasaki (JP)

(21) Appl. No.: 11/092,620

(22) Filed: Mar. 30, 2005

(30) Foreign Application Priority Data
Mar. 31, 2004 (JP) 105222/2004

(51) Int. Cl. G02F 1/136

(52) U.S. Cl. 349/42

(57) ABSTRACT

In a liquid crystal display panel for displaying image data by driving a number of pixel areas in a matrix array with thin-film transistors, a thin-film transistor in a display part and a peripheral thin-film transistor are formed as thin-film transistor of the same size (i.e., outer shape).

### BACKGROUND OF THE INVENTION

This application claims benefit of Japanese Patent Application No. 2004-105222 filed on Mar. 31, 2004, the contents of which are incorporated by the reference.

The present invention relates to method of manufacturing liquid crystal display panel and manufacturing method thereof and, more particularly, to a liquid crystal display panel and a method of manufacturing a high resolution liquid crystal display panel using thin-film transistors (TFT).

Liquid crystal display panel is operable with relatively low operating voltage and power consumption and also small (or thin) in size and light in weight, and is thus readily used as display panel of television (TV) receiver and personal computer (PC). Nowadays, liquid crystal display panel is tending to preclude conventional cathode-ray tubes (CRT).

Liquid crystal display and method of manufacturing the same are disclosed in various literatures. FIG. 3 is an exploded fragmentary perspective view for describing the structure of a usual liquid crystal display panel (see Literature 1: Japanese Patent Laid-open 2003-347314, for instance). This liquid crystal display panel 30 comprises an upper (or outer) substrate 31, a lower (or inner) substrate 32, a common electrode 33, a black matrix 34, color filter layers 35 of R (red), G (green) and B (blue) colors, a liquid crystal layer 36 having a number of pixel areas P, TFT transistors T each formed in correspondence to each pixel area P, gate lead lines 37, pixel electrodes (i.e., TFT drains) 38 and data lead lines (i.e., TFT sources). In this liquid crystal display panel 30, a constant voltage is applied to the common electrode 33. A desired image is displayed with liquid crystal orientation control of the liquid crystal layer 36 of each pixel area P therein by turning on (i.e., causing conduction of) the corresponding TFT transistor with application of a select signal and image data to the gate lead line 37 and the pixel electrode 38, respectively, of the TFT transistor T.

The essential part of the usual method of manufacturing a TFT transistor in the liquid crystal display panel as described above, will now be described with reference to FIGS. 4(a) to 4(b). As shown in FIG. 4(a), a gate pattern G is formed on glass plate (not shown). Then, an SiN film is formed as insulating film over the gate pattern G. Then, a semiconductor film 42 is formed atop the SiN film. Finally, a photo-resist film is formed on the surface and exposed to ultraviolet radiation via a photo-mask 44, thereby forming a photo-resist pattern 43 (the above process being referred to as I-step). Then, as shown in FIG. 4(b), the semiconductor film 42 is selectively etched by using the photo-resist pattern 43, thereby forming a channel part 45 of the TFT transistor (I-DE step). Then, as shown in FIG. 4(c), an electric conductor film 46 and a photo-resist film are formed on the surfaces of the substrate 41 and the channel part 45, and a photo-resist pattern 47 is formed above the channel part 45 by using a separate photo-mask 48 (D-step). Then, as shown in FIG. 4(d), the wafer is etched by using the photo-resist pattern 47, thereby forming a source S and a drain D of the TFT transistor (D-WE step). Thereafter, a protective film and the like are formed. This step, however, is of a well-known technique, and will not be described.

Recently, a technique of adopting, in the formation of source and drain parts of a TFT part, gray tone exposure for channel part to carry out, with a single mask, the formation of a TFT area part and the formation of a channel (i.e., separation of source and drain electrode parts), has been proposed and disclosed as an example of step reduction of array process (see Literature 2: Japanese Patent Laid-open 2002-55364, for instance). The method of adopting the gray tone exposure for the manufacture of a liquid crystal display panel, will now be described with reference to FIGS. 5(A) and 5(B) and FIGS. 6(a) to 6(e). FIGS. 5(A) and 5(B) show a photo-mask used for the gray tone exposure. FIG. 5(A) is a plan view showing the photo-mask 50. FIG. 5(B) is a sectional view taken along line B-B′ in FIG. 5(A).

As shown in FIGS. 5(A) and 5(B), the photo-mask 50 has a shield (i.e., non-transparent) pattern 53, which is formed on the surface (i.e., bottom surface) of the transparent substrate 51 and has a predetermined pattern constituted by a first to a third shield pattern 52 to 54. Referring to FIGS. 5(A) and 5 (B), symbol A designates a transparent area, symbol B designates a shield area, and symbol C designates a semi-transparent area. The first shield pattern 52 corresponds to the source-drain area of the TFT part formed by using the photo-mask 50. The second shield pattern 53 corresponds to the channel area of the TFT part.

FIGS. 6(a) to 6(e) illustrate the method of manufacture, by using the photo-mask 50 shown in FIG. 5, of a liquid crystal display panel or a TFT transistor therein. In FIGS. 6(a) to 6(e), reference numeral 61 designates a glass substrate, reference numeral 62 designates a gate electrode, reference numeral 63 designates a gate insulating film, reference numeral 64 designates an a-Si film, reference numeral 65 designates an n+a-Si film, reference numeral 66 designates a metal film for source and drain, and reference numeral 67 designates a photo-sensitive film. Reference symbols 66a and 66b designate a source and a drain, respectively. Reference symbol 67a designates a photo-sensitive film pattern.

As shown in FIG. 6(a), a wafer of eventual TFT transistor 60 comprises the glass substrate 61, on which, i.e., on he front (or top) surface of which, the gate electrode 62, the gate insulating film 63, the a-Si film 64, the n+a-Si film 65, the metal film 66 for source and drain and the photo-sensitive film 67 are formed. In this state, a half film thickness part (or recess) 68 is formed in a channel part of the photo-sensitive film 67 by using the photo-mask 50 shown in FIG. 5 (see FIG. 6(b)). Then, the metal film 66 for source and drain is selectively etched (see FIG. 6(c)). Then, the half film thickness part 68 of the photo-sensitive film 67, i.e., the metal film 66 for source and drain in the channel part, is etched to separate the source 66a and the drain 66b (see FIG. 6(d)). Finally, the remaining photo-sensitive film pattern 67a is removed to complete the TFT transistor 60 (see FIG. 6(e)).

As shown above, in this prior art technique, the gate electrode 62 is deposited by spatter deposition, for instance, on the glass substrate 61. The pattern of the gate electrode 62 thus formed is then etched by the litho-photographic method to form the desired gate electrode 62. Then, the gate insulating film 63, for instance SiN film, and a channel active layer, i.e., a-Si film, are formed on the gate electrode 62. Then, the n+a-Si film 65 for connection to the source and drain electrodes is formed by continuous film formation by using the CVD (chemical vapor deposition) method. Furthermore, the source-drain electrode (i.e., metal film) 66 is deposited on the n+a-Si film 65 by the spatter method. Subsequently, the photo-sensitive film (i.e., photo-resist) is coated. Then, the source-drain electrode is processed by using the “gray-tone mask”, i.e., the photo-mask 50, to form a perfectly exposed area (i.e., outside the TFT area), a partly exposed area (i.e., channel part area between the source and drain electrodes 66a and 66b, and a perfectly unexposed area (i.e., area of the source and drain electrodes 66a and 66b).

By the term “gray-tone mask” is meant a mask (i.e., photo-mask) constituted by an area obtained by reducing the photo-resist by only one-half thickness thereof with disposition of the perfectly exposed area, the perfectly unexposed area and a fine pattern of a resolution lower than the threshold resolution of the exposing device. When the TFT part is formed by pattern forming in the above way, a sectional profile is obtained, in which only the photo-resist of the channel part between the source and drain electrodes is reduced in thickness by the partial exposure. Subsequently, the source-drain electrode film is dry etched (DE) by using the photo-resist pattern as mask. In this dry etching, not only the source-drain electrode film but also the n+a-Si film 65 and the a-Si film 64 are etched, with the SiN film as the gate insulating film 63 used as stopper. Then, the photosensitive (i.e., photo-resist) film 68 on the channel part is removed by ashing.

Afterwards, to form the channel area of the TFT part, dry etching is made by using the photo-resist pattern 67a to form the source and drain electrodes 66a and 66b. In this dry etching, the source and drain electrodes 66a and 66b and the n+a-Si film 65 are etched as well, and the channel active layer is made to serve as stopper. Thus, the channel area is formed. Finally, the photo-resist 67 is peeled off. In the above way, it is possible, by using the photo-mask 50 a single time, to form the TFT part (i.e., TFT transistor) and reduce the steps of manufacture of the TFT or liquid crystal display panel.

The above method, in which the gray-tone mask is used for manufacturing the liquid crystal display panel or TFT parts thereof, has a merit that it is possible to reduce the steps of manufacture. On the demerit side, however, the process margin is very narrow, so that it is difficult to form TFT transistors of different sizes with the same mask.

### SUMMARY OF THE INVENTION

The present invention was made in view of the above problem inherent in the prior art, and it has an object of providing a liquid crystal display panel and manufacture method thereof, which permits forming TFT transistors of different W/L values without changing the outer shape of the transistors.

According to an aspect of the present invention, there is provided a liquid crystal display panel for displaying image data by driving a number of pixel areas in a matrix array with thin-film transistors, wherein a thin-film transistor in a display part and a peripheral thin-film transistor are formed as thin-film transistor of the same size.

According to another aspect of the present invention, there is provided a manufacturing method of a liquid crystal display panel for displaying image data by driving a number of pixel areas in a matrix array with thin-film transistors (TFTs), wherein a TFT in a display part and a peripheral TFT are formed as TFTs of the same size (i.e., outer shape).

The TFT in the display part and the peripheral protective TFT are formed by using a gray-tone mask having a pattern of a size less than the threshold resolution of an imaging device.

According to other aspect of the present invention, there is provided a method of manufacturing a liquid crystal display panel comprising the steps of: forming a desired gate electrode by depositing an eventual gate electrode by spattering on one surface of a glass substrate, forming the pattern of the gate electrode by a photo-lithographic method and etching the resultant wafer; forming an SiN film as gate insulating film and an a-Si film as channel active layer on the other surface of the glass substrate over the gate electrode; forming, for connection to source and drain electrodes, an n+a-Si film by continuous film formation adopting the CVD method; depositing a source-drain electrode on the n+a-Si film by using a spattering method; processing, after photo-resist coating and by using a gray-tone mask, the source-drain electrode to form a perfectly exposed area (outside TFT area and source bus line), a partly exposed area (i.e., channel part area CH between the source and drain electrodes, and a perfectly unexposed area (i.e., area of source and drain electrode parts and source bus line), dry etching, by using the photo-resist pattern as mask and the SiN film, i.e., gate insulating film, as stopper, the source-drain electrode film, the source bus line, the n+a-Si film and the a-Si film, thereby effecting etching up to the n+a-Si film and the a-Si film in the part, in which the photo-resist is perfectly removed, in the protective transistor having the channel part obtained with an exposure mask having a slit pattern of a resolution higher than the threshold resolution of an imaging device and thus reducing the effective W of the protective transistor, followed by ashing to remove the photo-resist film on the channel part; forming the channel area by dry etching up to the source-drain electrode and the n+a-Si film by using the photo-resist pattern and also using the channel active layer as stopper; and peeling off the photo-resist, thereby forming TFTs having the same outer shape and different in the effective W/L.

Other objects and features will be clarified from the following description with reference to attached drawings.

### BRIEF DESCRIPTION OF THE DRAWINGS

FIGS. 1(a) to 1(e) are sectional views showing main steps of manufacture of the TFT part formed on a glass substrate of a liquid crystal display panel according to the present invention;

FIGS. 2(a) to 2(e) are plan views of an essential part of the liquid crystal display panel corresponding to FIGS. 1(e) to 1(e) according to the present invention;

FIG. 3 is an exploded fragmentary perspective view for describing the structure of a usual liquid crystal display panel;

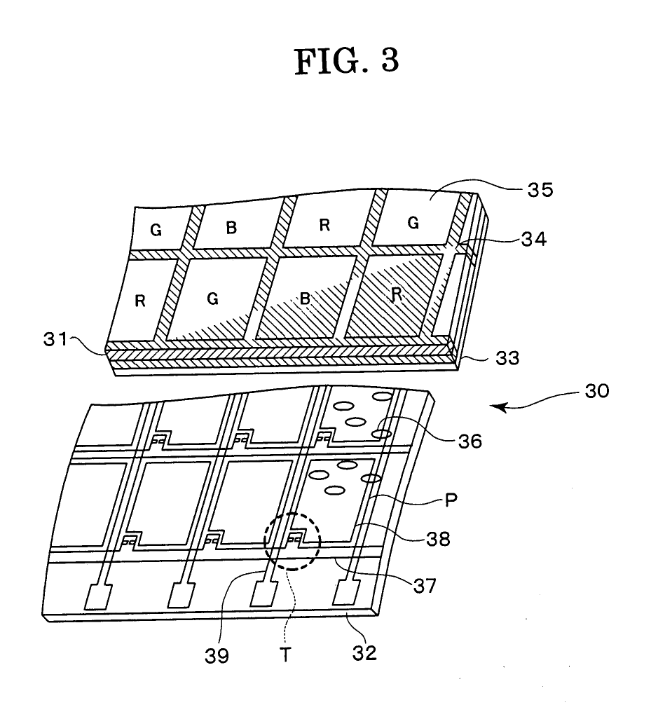

FIGS. 4(a) to 4(b) show essential parts of the usual method of manufacturing a TFT transistor in the liquid crystal display panel;

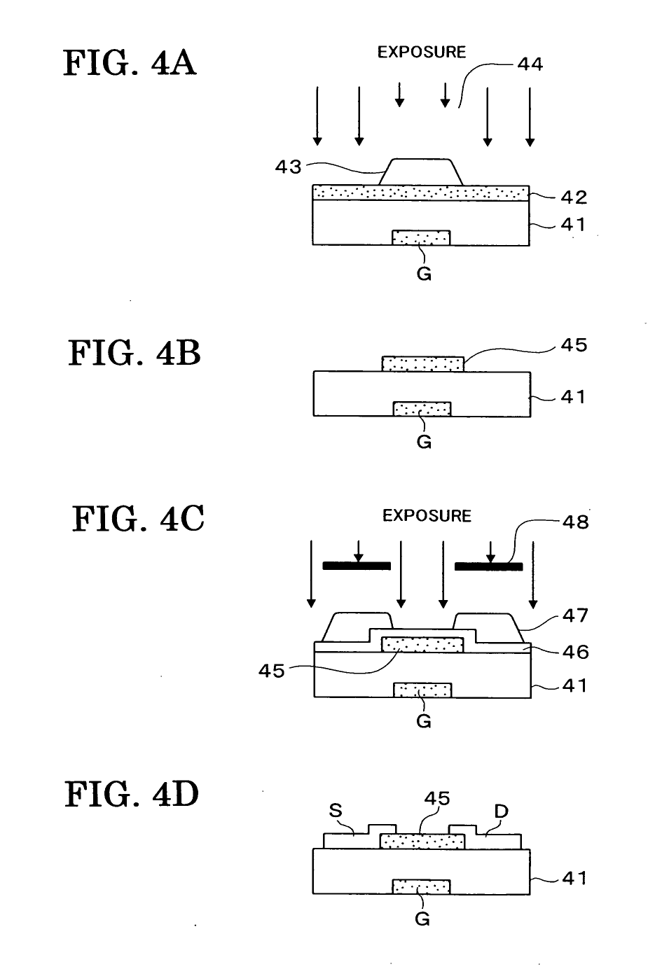

FIGS. 5(A) and 5(B) are a plan view showing the photo-mask 50 and a sectional view taken along line B-B′ in FIG. 5(A); and

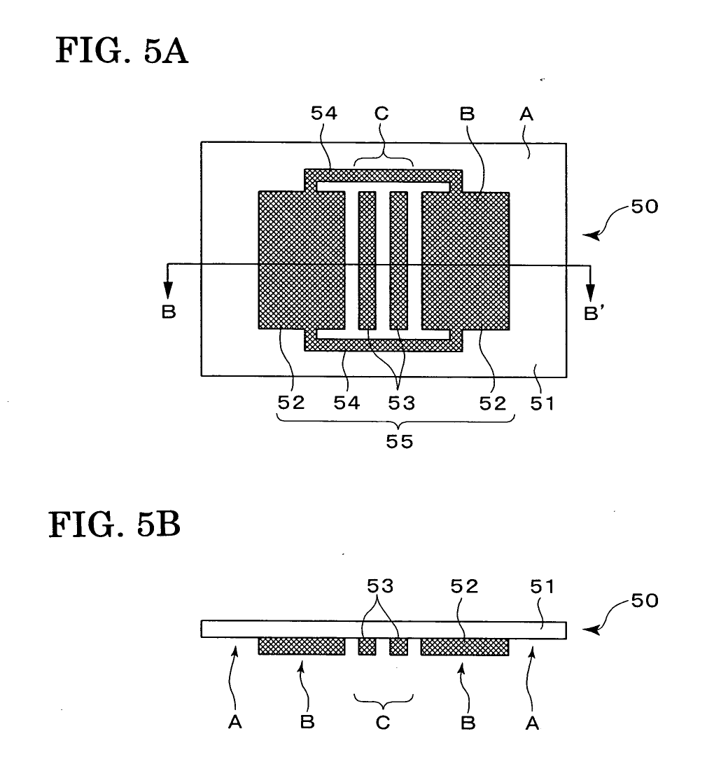

FIGS. 6(a) to 6(e) show method of manufacture, by using the photo-mask 50 shown in FIG. 5, of a liquid crystal display panel or a TFT transistor therein.

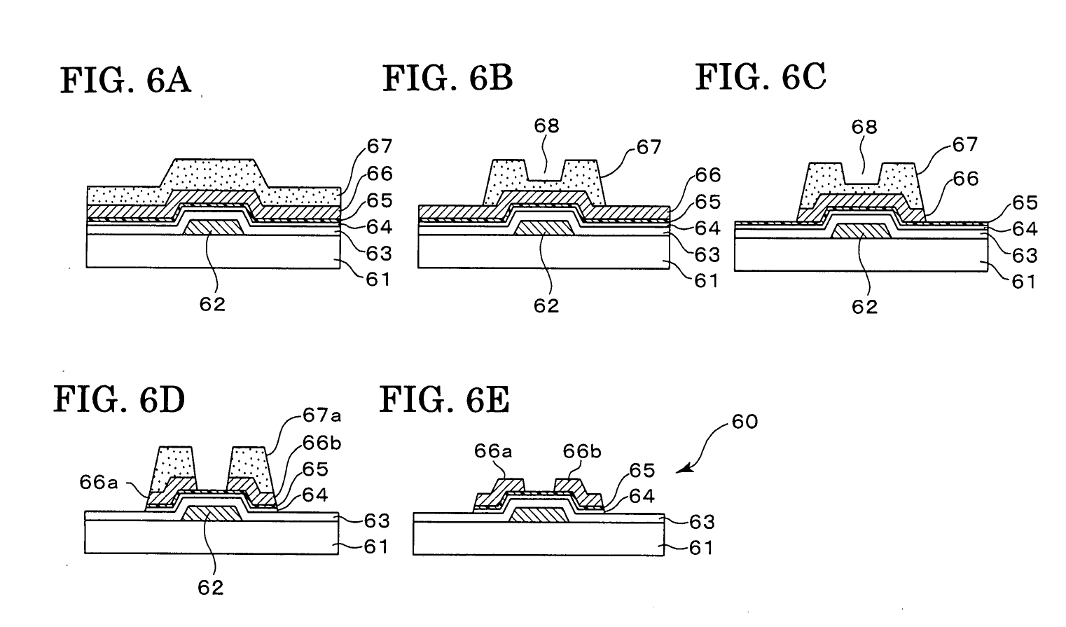

### PREFERRED EMBODIMENTS OF THE INVENTION

Preferred embodiments of the present invention will now be described with reference to the drawings.

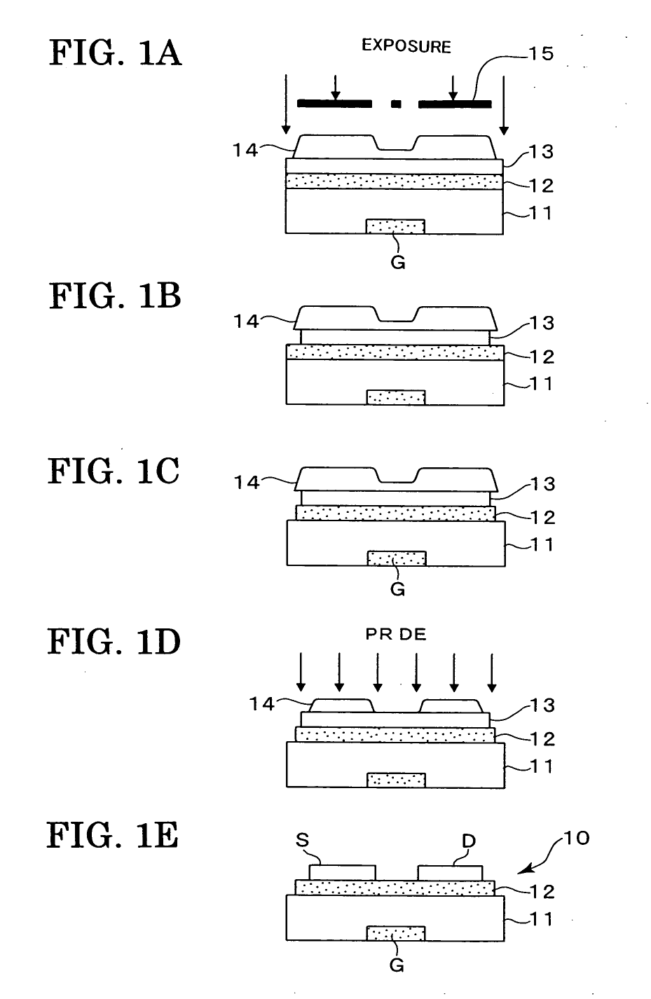

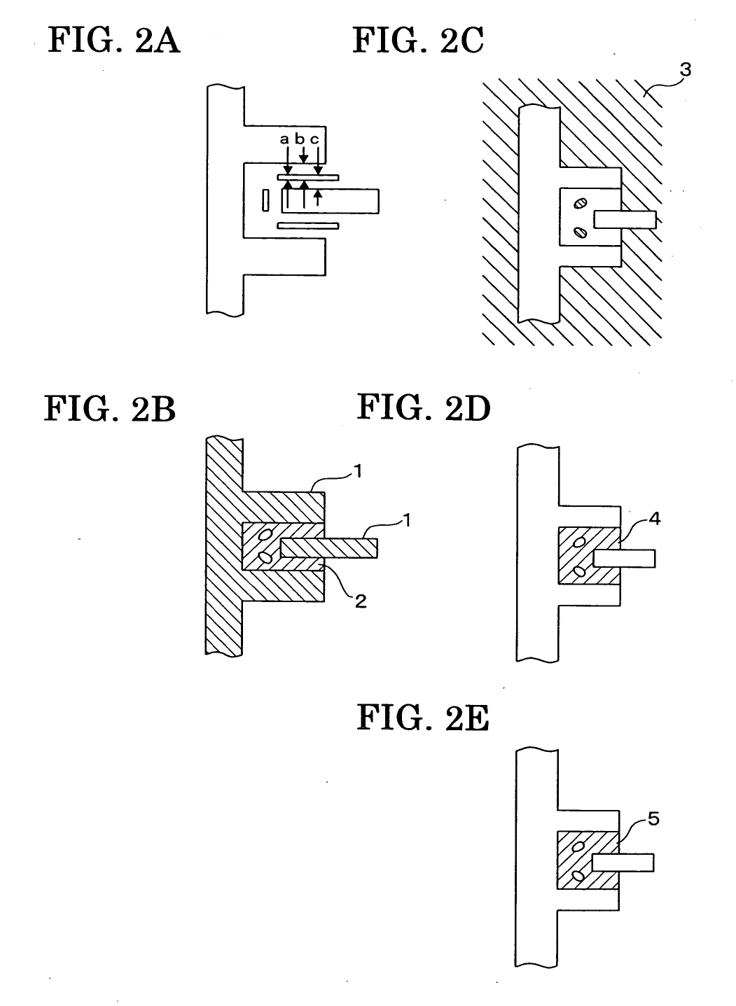

FIGS. 1(a) to 1(e) and 2(a) to 2(e) are manufacturing step views showing a liquid crystal display panel according to the present invention, particularly for describing the method of manufacturing the TFT part. FIGS. 1(a) to 1(e) are sectional views showing main steps of manufacture of the TFT part formed on a glass substrate of a liquid crystal display panel. FIGS. 2(a) to 2(e) are plan views of an essential part of the liquid crystal display panel corresponding to FIGS. 1(e) to 1(e).

In a DI step of FIG. 1(a), a first pattern is formed with photo-lithographic techniques. In this step, a half photo-resist film thickness part is formed by using a pattern with a resolution lower than the threshold resolution for a channel part. In a step of FIG. 1(b), a D lead line is formed. In a step of FIG. 1(c), n+a-Si (amorphous) film and a-Si are formed. In a step of FIG. 1(d), a second pattern is formed by PR (photo-resist)-DE. The half photo-resist film thickness part is removed. In a step of FIG. 1(e), channel part metal and n+a-Si film are formed. The process will be described hereinafter in greater details.

A gate pattern G is formed on a glass substrate (not shown). On the gate pattern are formed a SiN film as insulating film and an a-Si film 12 as channel active layer. For connection to source and drain electrodes, an n+a-Si film is formed by continuous formation using the CVD method. A source-drain electrode 13 is formed by the spattering method on the n+a-Si film. Photo-resist 14 is then coated. Then, the source-drain electrode is processed by using a gray-tone mask 15 to form a perfectly exposed area (outside TFT area and source bus line), a partly exposed area (i.e., channel part area CH between the source and drain electrodes) and a perfectly unexposed area (i.e., source-drain electrode part and source bus line area).

In the wafer thus obtained, the display part TFT transistor and the outer peripheral part protective transistor in the liquid crystal display panel, although the same in the outer shape, are different in the slit pattern of the resolution lower than the threshold resolution of the imaging device. Specifically, in the display part a slit is disposed over the entire channel part, while in the protective transistor part slits of a resolution higher than the threshold resolution is provided in corner parts. Thus, while photo-resist of one-half the film thickness is formed over the entire surface of the protective transistor channel part, the protective transistor channel part has parts, in which the photo-resist is perfectly removed. While the displayed example concerns positive photo-resist, this is by no means limitative.

As shown above, with pattern formation of the TFT part, a photo-resist sectional profile, in which only the photo-resist in the channel part area between the source and drain is reduced in thickness, is obtained as a result of exposure of part of the photo-resist film thickness. With this photo-resist pattern 14 used as mask, the source-drain electrode film is dry etched. In this dry etching, not only the source-drain electrode film but also the source bus line, the n+a-Si film and the a-Si film are etched. The SiN film as gate insulating film is used as stopper.

In this case, the protective transistor with the slit pattern having a resolution lower than the threshold resolution disposed in the exposure mask 15, the effective W can be reduced because the n+a-Si film and the a-Si film in the part, in which the photo-resist is perfectly removed, are etched as well. Subsequently, ashing is made to remove the photo-resist film 14 on the channel part CH.

Subsequently, for forming the channel area CH in the TFT part, dry etching is made by using the photo-resist pattern, thereby forming the source and drain part electrodes. In this dry etching, the channel area is formed by the etching of the source-drain electrode and the n+a-Si film as well with the channel active layer used as stopper. Finally, the photo-resist is peeled off. In this way, it is possible to form TFTs of the same outer shape and different in effective W/L by using a mask a single time and thus reduce the steps of manufacture.

Referring to FIGS. 2(a) to 2(e), as shown in FIG. 2(a), a mask with intervals a to c lower than the threshold resolution is used. FIG. 2(b) shows a photo-resist pattern after development. As shown, the photo-resist perfectly remains in shaded part 1, and half film thickness photo-resist remains in shaded part 2 (FIG. 1(a)). In FIG. 2(c), wiring pattern is formed by subjecting shaded part 3 to Cr-WE and I-DE steps (FIGS. 1(b) nd 1(c)). In FIG. 2(d), the half film thickness photo-resist in shaded part 4 is removed by executing PR-DE step (photo-resist in the perfectly remaining part thereof remains.) (FIG. 1(d)). In FIG. 2(e), CH is formed in shaded part 5 by executing Cr-WE and CH-DE steps (FIG. 1(e)).

With the method of manufacturing liquid crystal display panel according to the present invention, the following pronounced practical advantages are obtainable. With the display part transistor (hereinafter referred to as TFT transistor) and the peripherally disposed protective transistor, which are formed with the same outer shape design by using gray-tone mask exposure, it is possible to reduce the effective W (width) of the protective transistor alone by providing a slit pattern of a resolution lower than the threshold resolution of the imaging device to this transistor. Thus, it is possible to form TFT transistors different in W/L with process-saving 1RP (photo-resist) and reduce the cost of manufacture.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

1. A liquid crystal display panel for displaying image data by driving a number of pixel areas in a matrix array with thin-film transistors, wherein a thin-film transistor in a display part and a peripheral thin-film transistor are formed as thin-film transistor of the same size.

2. Manufacturing method of a liquid crystal display panel for displaying image data by driving a number of pixel areas in a matrix array with thin-film transistors (TFTs), wherein a TFT in a display part and a peripheral TFT are formed as TFTs of the same size (i.e., outer shape).

3. The method of manufacturing the liquid crystal according to claim 2, wherein the TFT in the display part and the peripheral protective TFT are formed by using a gray-tone mask having a pattern of a size less than the threshold resolution of an imaging device.

4. A method of manufacturing a liquid crystal display panel comprising the steps of:
forming a desired gate electrode by depositing an eventual gate electrode by spattering on one surface of a glass substrate, forming the pattern of the gate electrode by a photo-lithographic method and etching the resultant wafer;
forming an SiN film as gate insulating film and an a-Si film as channel active layer on the other surface of the glass substrate over the gate electrode;
forming, for connection to source and drain electrodes, an n+a-Si film by continuous film formation adopting the CVD method;
depositing a source-drain electrode on the n+a-Si film by using a spattering method;
processing, after photo-resist coating and by using a gray-tone mask, the source-drain electrode to form a perfectly exposed area (outside TFT area and source bus line), a partly exposed area (i.e., channel part area CH between the source and drain electrodes, and a perfectly unexposed area (i.e., area of source and drain electrode parts and source bus line),
dry etching, by using the photo-resist pattern as mask and the SiN film, i.e., gate insulating film, as stopper, the source-drain electrode film, the source bus line, the n+a-Si film and the a-Si film, thereby effecting etching up to the n+a-Si film and the a-Si film in the part, in which the photo-resist is perfectly removed, in the protective transistor having the channel part obtained with an exposure mask having a slit pattern of a resolution higher than the threshold resolution of an imaging device and thus reducing the effective W of the protective transistor, followed by ashing to remove the photo-resist film on the channel part;
forming the channel area by dry etching up to the source-drain electrode and the n+a-Si film by using the photo-resist pattern and also using the channel active layer as stopper; and
peeling off the photo-resist, thereby forming TFTs having the same outer shape and different in the effective W/L.
